(19) United States
(12) Patent Application Publication
(10) Pub. No.: US 2019/0136524 A1
(43) Pub. Date: May 9, 2019

(54) WATER STAIN AND SAG RESISTANT ACOUSTIC BUILDING PANEL

(71) Applicant: ARMSTRONG WORLD INDUSTRIES, INC., Lancaster, PA (US)

(72) Inventor: Jian Zhang, Shanghai (CN)

(21) Appl. No.: 15/866,845

(22) Filed: Jan. 10, 2018

(30) Foreign Application Priority Data
Nov. 9, 2017 (CN) 2017110957836

(51) Int. Cl. E04B 9/04; C09D 5/03; C09D 5/16

(52) U.S. Cl. CPC E04B 9/045; E04B 2001/742; C09D 5/1687; C09D 5/033

(57) ABSTRACT

Described herein is a water repellent building panel having a first major surface opposite a second major surface and side surfaces extending between the first and second major surfaces, the building panel comprising: a body having an upper surface opposite a lower surface and side surfaces extending between the upper and lower surfaces; and a coating applied to the upper surface of the body, the coating comprising a hydrophobic agent that is a blend of an olefin and a non-ionic fatty-alcohol, wherein the body is substantially free of the hydrophobic agent.

### CROSS-REFERENCE TO RELATED APPLICATIONS

This application claims the benefit of Chinese Patent Application No. 2017110957836, filed Nov. 9, 2017. The disclosure of the above application is incorporated herein by reference.

### BACKGROUND

Building panels tend to become stained and/or lose mechanical integrity and sag when exposed to water. Water may contact a building panel in the form of droplets that originate from condensation or a leak on pipes and ductwork that are located in the space above the ceiling. The water can drip onto the backside of the building panel and migrate to the visible appearance side of a panel. Staining can occur because the water can carry off contaminants from surfaces it contacts and, often, because the water droplets migrate through the building panel and leach tannin from recycled newsprint or other plant based cellulose materials, as well as inorganic staining agents, from other components used in the tile composition bringing such staining agents to the front surface of the panel. Thus, there exists a need for a water-repellant building panel that avoids problems due to discoloration and sagging after exposure to water.

### BRIEF SUMMARY

The present invention is directed to a water repellent building panel having a first major surface opposite a second major surface and side surfaces extending between the first and second major surfaces, the building panel comprising a body having an upper surface opposite a lower surface and side surfaces extending between the upper and lower surfaces, and a coating applied to the upper surface of the body, the coating comprising a hydrophobic agent that is a blend of an olefin and a non-ionic fatty-alcohol, wherein the body is substantially free of the hydrophobic agent.

Other embodiments of the present invention include a water-repellent building panel comprising a body having a first volume as defined by plurality of outermost surfaces, the body comprising a core that is encapsulated by the plurality of outermost surfaces; and a coating applied to at least one of the outermost surfaces of the body, the coating comprising a hydrophobic agent that is a blend of olefin and a non-ionic fatty-alcohol, wherein the core of the body is substantially free of the hydrophobic agent.

Other embodiments of the present invention include a method of forming a water-repellent panel comprising a) providing a body having a first major surface opposite a second major surface and side surfaces extending between the first and second major surfaces, the body being substantially free of water, b) applying a coating composition to the first major surface of the body, the coating comprising water and a hydrophobic agent that is a blend of olefin and a non-ionic fatty-alcohol, wherein the body in step a) is substantially free of the hydrophobic agent.

Other embodiments of the present invention include a ceiling system comprising a support grid, at least one ceiling panel supported by the support grid, the ceiling panel having a first major surface opposite a second major surface, the second major surface facing upward and the first major surface facing downward, wherein the ceiling panel comprises a body and a coating applied to the body, the coating comprising a hydrophobic agent that is a blend of olefin and a non-ionic fatty-alcohol, and wherein the body is substantially free of the hydrophobic agent.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is top perspective view of a building panel according to the present invention;

FIG. 2 is a cross-sectional view of the building panel according to the present invention, the cross-sectional view being along the IV line set forth in FIG. 1;

FIG. 3 is top perspective view of an un-coated body according to the present invention;

FIG. 4 is a cross-sectional view of the uncoated body, the cross-sectional view being along the II line set forth in FIG. 3;

FIG. 5 is a ceiling system comprising the building panel of the present invention.

FIG. 6 is a cross-sectional close-up view of the edges of the building panels according to the present invention.

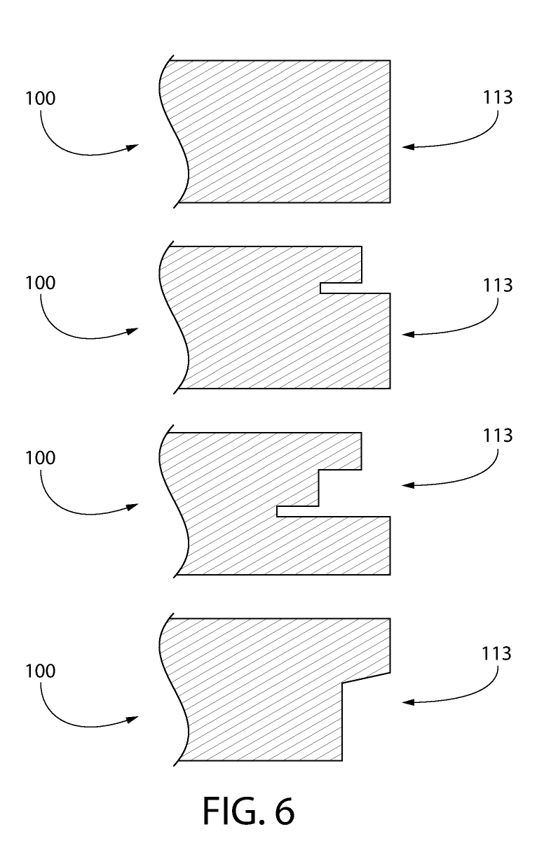

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” less than about 0.1 wt. % based on the total of the referenced value.

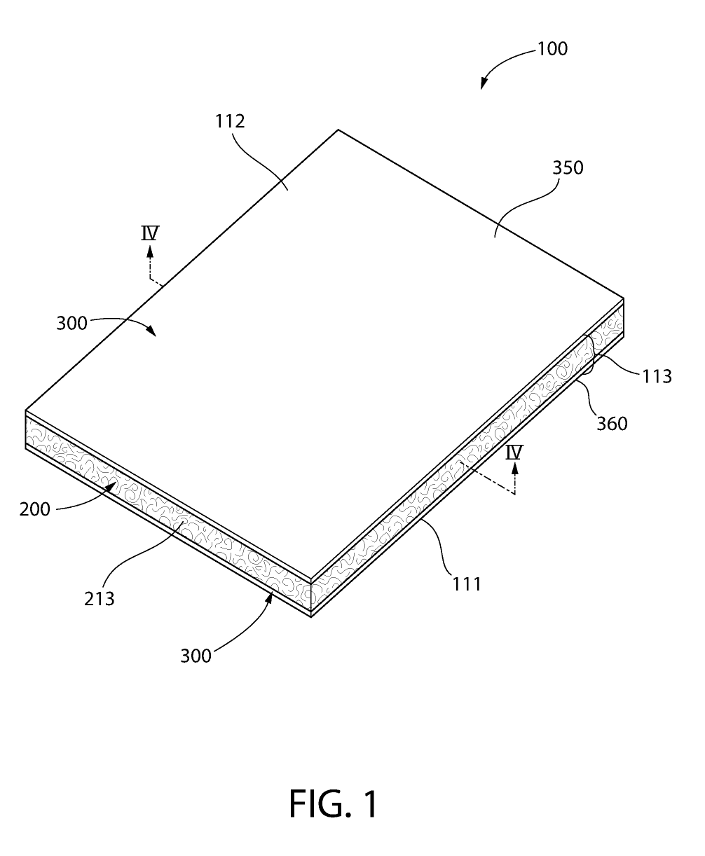

Referring to FIG. 1, the building panel 100 of the present invention may comprise a first major surface 111 opposite a second major surface 112. The ceiling panel 100 may further comprise a side surface 113 that extends between the first major surface 111 and the second major surface 112, thereby defining a perimeter of the ceiling panel 100.

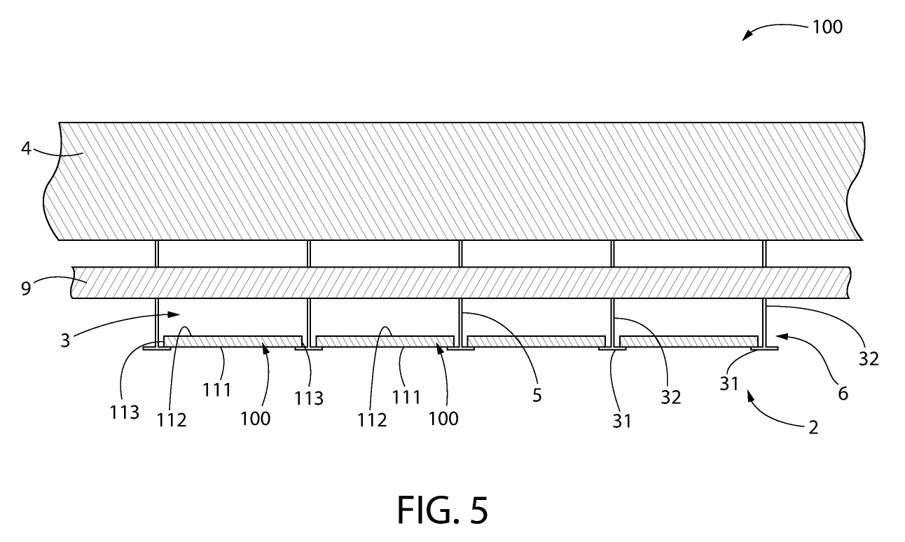

Referring to FIG. 5, the present invention may further include a ceiling system 1 comprising one or more of the building panels 100 installed in an interior space, whereby the interior space comprises a plenary space 3 and an active room environment 2. The plenary space 3 provides space for mechanical lines 9 within a building (e.g., HVAC, plumbing, etc.). The active space 2 provides room for the building occupants during normal intended use of the building (e.g., in an office building, the active space would be occupied by offices containing computers, lamps, etc.).

In the installed state, the building panels 100 may be supported in the interior space by one or more parallel support struts 5. Each of the support struts 5 may comprise an inverted T-bar having a horizontal flange 31 and a vertical web 32. The ceiling system 1 may further comprise a plurality of first struts that are substantially parallel to each other and a plurality of second struts that are substantially perpendicular to the first struts (not pictured). In some embodiments, the plurality of second struts intersects the plurality of first struts to create an intersecting ceiling support grid 6. The plenary space 3 exists above the ceiling support grid and the active room environment 2 exists below the ceiling support grid 6.

In the installed state, the first major surface 111 of the building panel 100 faces the active room environment 2 and the second major surface 112 of the building panel 100 faces the plenary space 3. The building panels 100 of the present invention have superior stain and sag resistance without sacrificing the desired airflow properties required for the building panels 100 to functional as acoustical ceiling tiles—as discussed further herein.

The ceiling system 1 of the present invention may include the ceiling support grid 6 and at least one building panel 100 supported by the ceiling support grid, the building panel 100 having the first major surface 111 opposite the second major surface 112, and the second major surface 112 facing upward and the first major surface 111 facing downward.

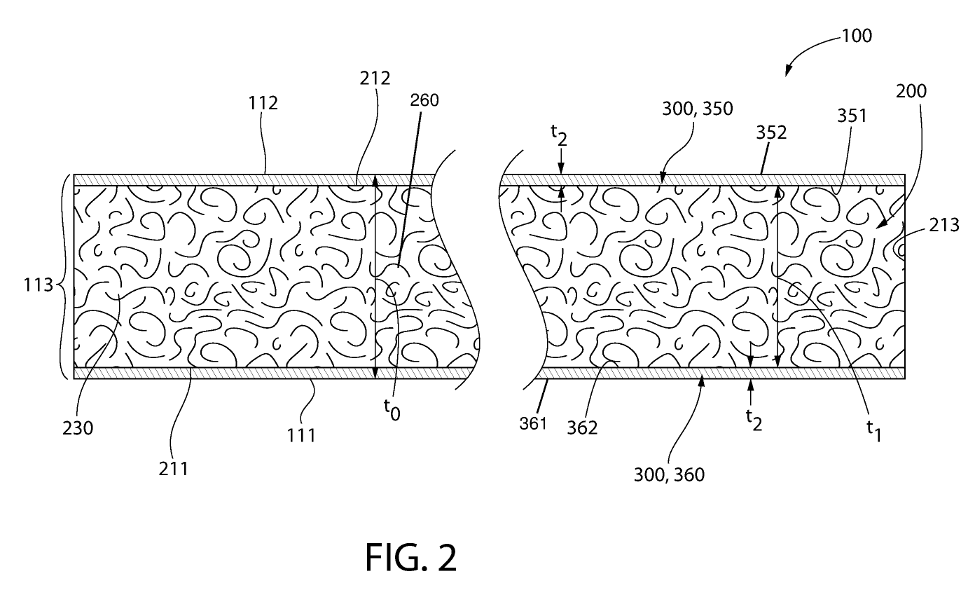

Referring now to FIGS. 1 and 2, the building panel 100 of the present invention may have a panel thickness t₀ as measured from the first major surface 111 to the second major surface 112. The panel thickness t₀ may range from about 12 mm to about 40 mm—including all values and sub-ranges there-between. The building panel 100 may have a length ranging from about 30 cm to about 310 cm—including all values and sub-ranges there-between. The building panel 100 may have a width ranging from about 10 cm to about 125 cm—including all values and sub-ranges there-between.

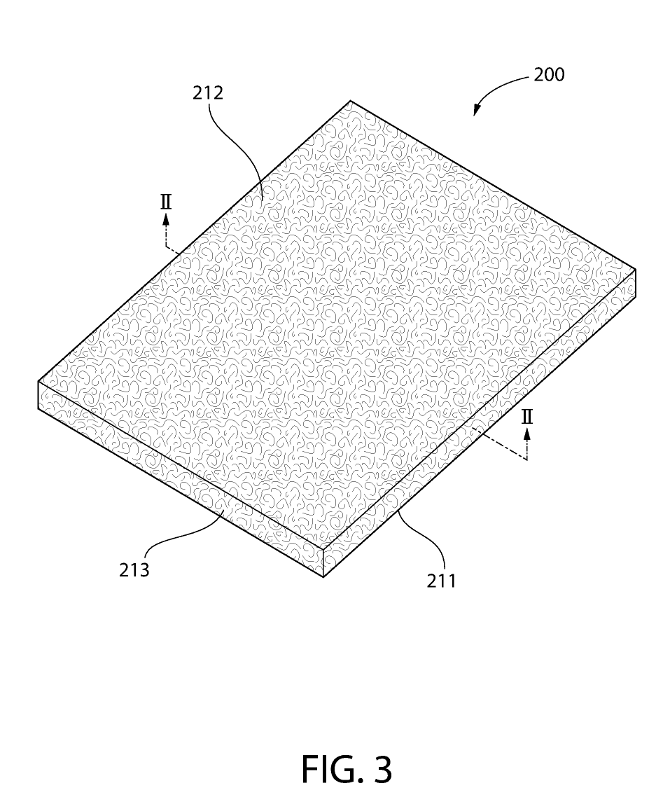

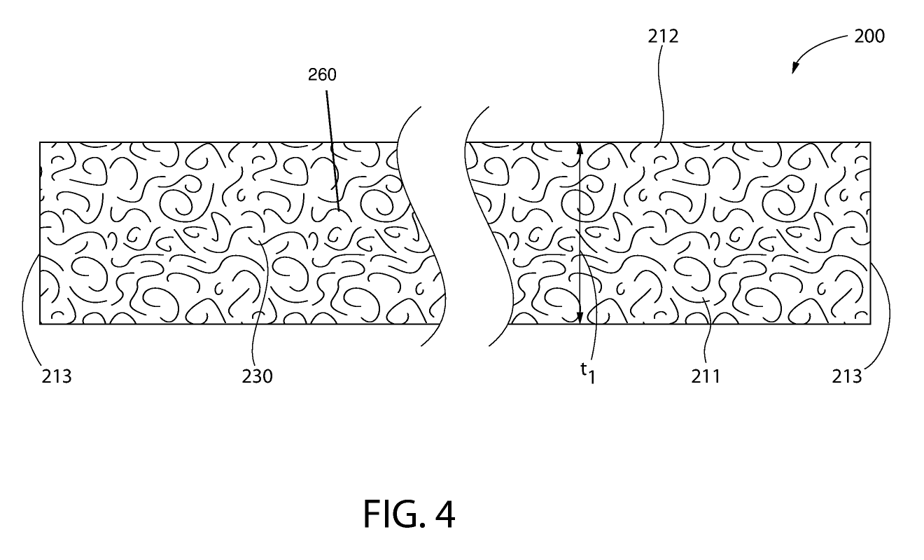

Referring now to FIGS. 1-4, the building panel 100 may comprise a body 200 having an upper surface 212 opposite a lower surface 211 and a body side surface 213 that extends between the upper surface 212 and the lower surface 212, thereby defining a perimeter of the body 120. The body 200 may have a body thickness t₁ that extends from the upper surface 212 to the lower surface 211. The body thickness t₁ may range from about 12 mm to about 40 mm—including all values and sub-ranges there-between.

Although not pictured, the first major surface 111 of the building panel 100 may comprise the lower surface 211 of the body 200. Although not pictured, the second major surface 112 of the building panel 100 may comprise the upper surface 212 of the body 200. When the first major surface 111 of the building panel 100 comprises the lower surface 211 of the body 200, a hydrophobic coating 300 is applied to upper surface 212 of the body 200 in the form of a back-coating 350, such that the second major surface 112 of the building panel 100 comprises the hydrophobic coating 300, which is the back-coating 350—as discussed in greater detail herein. When the second major surface 112 of the building panel 100 comprises the upper surface 212 of the body 200, the hydrophobic coating 300 is applied to lower surface 211 of the body 200 in the form of a face-coating 360, such that the first major surface 111 of the building panel 100 comprises the hydrophobic coating 300 in the form of the face-coating 360—as discussed in greater detail herein. In other embodiments, the hydrophobic coating 300 is applied to both the upper surface 212 and the lower surface 211 of the body 200 such that the first major surface 111 and the second major surface 112 of the building panel 100 comprise the hydrophobic coating 300—as discussed in greater detail herein. In such embodiments, the building panel 100 comprises both the back-coating 350 and the face-coating 360.

According to the present invention, the term “hydrophobic” means a composition that is extremely difficult to wet and is capable of repelling liquid water under atmospheric conditions. Thus, as used herein, the term “hydrophobic” refers to a surface that generates a contact angle of greater than 90° with a reference liquid (i.e. water).

The notion of using the contact angle made by a droplet of liquid on a surface of a solid substrate as a quantitative measure of the wetting ability of the particular solid has also long been well understood. Wetting is the ability of a liquid to maintain contact with a solid surface, resulting from intermolecular interactions when the two are brought together. The degree of wetting (wettability) is determined by a force balance between adhesive and cohesive forces. If the contact angle is greater than 90° for the water droplet to the substrate surface then it is usually considered to be hydrophobic. For example, there are materials on which liquid droplets have high contact angles, such as water on paraffin, for which there is a contact angle of about 107°.

The hydrophobic coating 300 may comprise a hydrophobic agent. The hydrophobic agent may be a blend of a first component and second component. The first component may be a wax. The second component may be non-ionic fatty alcohol. In a preferred embodiment, the hydrophobic component is a blend of the wax and the non-ionic fatty alcohol. The hydrophobic agent may further comprise an emulsifier.

Non-limiting examples of wax include paraffin wax (i.e. petroleum derived wax), polyolefin wax, as well as naturally occurring waxes and blends thereof. Non-limiting examples of polyolefin wax include high density polyethylene (“HDPE”) wax, polypropylene wax, polybutene wax, polymethypentene wax, and combinations thereof. Naturally occurring waxes may include plant waxes, animal waxes, and combination thereof. Non-limiting examples of animal waxes include beeswax, tallow wax, lanolin wax, animal fax based wax, and combinations thereof. Non-limiting examples of plant waxes include soy-based wax, carnauba wax, ouricouri wax, palm wax, candelilla wax, and combinations thereof. In a preferred embodiment, the wax is paraffin wax.

The non-ionic fatty alcohol may be fatty alcohol-polyoxyethylene ether. The non-ionic fatty alcohol-polyoxyethylene ether may be phenolic. Non-limiting examples of non-ionic fatty alcohol-polyoxyethylene ether include oleyl alcohol polyoxyethylene ether, cetyl alcohol polyoxyethene ether, octylphenol polyoxyethylene, and blends thereof.

In a preferred embodiment, the hydrophobic agent is a blend of paraffin wax and non-ionic fatty alcohol-polyoxyethylene ether. In a preferred embodiment, the hydrophobic agent is a blend of paraffin wax, non-ionic fatty alcohol-polyoxyethylene ether, and emulsifier.

Non-limiting examples of emulsifier include (i) C7 to C18 alcohol, (ii) rosin (including esterified rosin), and (iii) blends of (i) and (ii).

The hydrophobic agent may be present in the hydrophobic coating 300 in an amount ranging from about 0.1 wt. % to about 15 wt. % based on the total weight of the hydrophobic coating 300 in a dry-state, including all values and sub-ranges there-between. In a preferred embodiment, the hydrophobic agent may be present in the hydrophobic coating 300 in an amount ranging from about 1 wt. % to about 10 wt. % based on the total weight of the hydrophobic coating 300 in a dry-state, including all values and sub-ranges there-between. As discussed in greater detail herein, the specific amount of hydrophobic agent may depend on the desired application of the hydrophobic coating 300—i.e., whether the hydrophobic coating 300 is a back-coating 350 or a face-coating 360.

The phrase “dry-weight” refers to the weight of a referenced component without the weight of any carrier. Thus, when calculating the weight percentages of components in the dry-state, the calculation should be based solely on the solid components (e.g., binder, filler, hydrophobic component, fibers, etc.) and should exclude any amount of residual carrier (e.g., water, VOC solvent) that may still be present from a wet-state, which will be discussed further herein. According to the present invention, the phrase “dry-state” may also be used to indicate a component that is substantially free of a carrier, as compared to the term “wet-state,” which refers to that component still containing various amounts of carrier—as discussed further herein.

The hydrophobic coating 300 may comprise binder. Non-limiting examples of binder may include a polyurethane binder, polyester binder, epoxy based binder (i.e., cured epoxy resin), polyvinyl alcohol (PVOH), a latex, and a combination of two or more thereof. The binder may be present in the hydrophobic coating 300 in an amount ranging from about 1 wt. % to about 25 wt. % based on the total weight of the hydrophobic coating 300—including all values and sub-ranges there-between—in the dry-state.

The hydrophobic layer 300 may comprise filler. Non-limiting examples of filler may include powders of calcium carbonate, including limestone, titanium dioxide, sand, barium sulfate, clay, mica, dolomite, silica, talc, perlite, polymers, gypsum, wollastonite, expanded-perlite, calcite, aluminum trihydrate, pigments, zinc oxide, or zinc sulfate. The filler may be present in an amount ranging from about 25 wt. % to about 99 wt. % based on the total dry weight of the hydrophobic coating 300—including all values and sub-ranges there-between.

The hydrophobic coating 300 may be applied to the body as a hydrophobic coating composition. The hydrophobic coating composition may be a water-based emulsion. The emulsion may be anionic or non-ionic. The emulsion may have a solid content ranging from about 20 wt. % to about 60 wt. % based on the total weight of the emulsion—including all value and sub-ranges there-between.

Referring now to FIGS. 1 and 2, the hydrophobic coating 300 may be present as back-coating 350 and/or a face-coating 360. The back-coating 350 comprises a lower surface 351 opposite an upper surface 352. The back-coating 350 may be immediately adjacent to the upper surface 212 of the body 200. The back-coating 350 may be applied directly to the upper surface 212 of the body 200 such that the lower surface 351 of the back-coating 350 contacts the upper surface 212 of the body 200. In some embodiments, the back-coating 350 may be partially absorbed by the body 200 and extend past the upper surface 212 of the body 200 to form at least part of an interface between the hydrophobic coating 300 and the body 200—as discussed in greater detail herein.

The back-coating 350 may comprises binder, filler, and/or additive as previously discussed. The back-coating 350 may comprise the hydrophobic agent in an amount ranging from about 1 wt. % to about 5 wt. % based on the total dry-weight of the back-coating 350—including all amounts and sub-ranges there-between. In other embodiments, the back-coating 350 may be substantially free of the hydrophobic agent—in such embodiments, the face-coating 360 comprises the hydrophobic agent. In a preferred embodiment, the back-coating 350 comprises the hydrophobic agent in an amount ranging from about 2 wt. % to about 5 wt. %—including all amounts and sub-ranges there-between.

The back-coating 350 may be present on upper surface 212 of the body 200 in an amount ranging from about 50 g/m² to about 250 g/m²—including all values and sub-ranges there-between. The back-coating 350 may be continuous.

The building panel 300 may comprise a face-coating 360 having a lower surface 361 opposite an upper surface 362. The face-coating 360 may be immediately adjacent to the lower surface 211 of the body 200. The face-coating 360 may be applied directly to the lower surface 211 of the body 200 such that the upper surface 362 of the second layer 360 contacts the lower surface 211 of the body 200.

The face-coating 360 may comprises binder, filler, and/or additive as previously discussed. The face-coating 360 may comprise the hydrophobic agent in an amount ranging from about 4 wt. % to about 12 wt. % based on the total dry-weight of the face-coating 360—including all amounts and sub-ranges there-between. In other embodiments, the face-coating 360 may be substantially free of the hydrophobic agent—in such embodiments, the back-coating 350 comprises the hydrophobic agent.

In some embodiments, the face-coating 360 forms a hydrophobic primer coating, whereby the hydrophobic agent is present in an amount of about 4 wt. % to about 6 wt. %—including all percentages and sub-ranges there-between—based on the total dry weight of the hydrophobic primer coating. The term “primer coating” refers to an intermediate coat which is subsequently coated with a finish coat. Therefore, the building panel 100 of the present invention may comprise the face-coating 300 as two sub-layers, whereby the first sub layer is the hydrophobic primer coat and the second sub layer is a finish coat applied atop the primer coat. In such embodiments, the finish coat may be substantially free of the hydrophobic agent. In a preferred embodiment, the face-coating 360 forms a hydrophobic primer coating having the hydrophobic agent present in an amount of about 5 wt. %—based on the total dry weight of the face-coating 360.

In other embodiments, the face-coating 360 forms a hydrophobic finish coating, whereby the hydrophobic agent is present in an amount ranging from about 8 wt. % to about 11 wt. %—including all percentages and sub-ranges there-between—based on the total dry-weight of the hydrophobic finish coating. In a preferred embodiment, the face-coating 360 comprises the hydrophobic agent in an amount of about 10 wt. %—based on the total dry weight of the face-coating 360.

The face-coating 360 may be present on the lower surface 211 of the body 200 in an amount ranging from about 50 g/m² to about 250 g/m²—including all values and sub-ranges there-between. The face-coating 360 may be discontinuous.

The upper surface 352 of the back coating 350 may form the top-most surface of the building panel 100. Stated otherwise, the second major surface 112 of the building panel 100 may comprise the upper surface 352 of the face-coating 350. The lower surface 361 of the face-coating 360 may form the lower-most surface of the building panel 100. Stated otherwise, the first major surface 111 of the building panel 100 may comprise the lower surface 361 of the face-coating 360. Additionally, the side surface 113 of the building panel 100 may comprise the side surfaces 213 of the body 200.

In some embodiments, the back-coating 350 may be partially absorbed by the body 200 and extend past the upper surface 212 of the body 200 to form at least part of an interface between the hydrophobic coating 300 and the body 200—as discussed in greater detail herein.

The body 200 may be porous, thereby allowing airflow through the body 200 between the upper surface 212 and the lower surface 211—as discussed further herein. The body 200 may be formed from a binder and fibers 230. Although not pictured, in other embodiments, the body 200 may be formed from a non-fibrous material—such as gypsum. In some embodiments, the body 200 may further comprise a filler and/or additive.

Non-limiting examples of binder may include a starch-based polymer, polyvinyl alcohol (PVOH), a latex, polysaccharide polymers, cellulosic polymers, protein solution polymers, an acrylic polymer, polymaleic anhydride, epoxy resins, or a combination of two or more thereof.

The binder may be present in an amount ranging from about 1 wt. % to about 25 wt. % based on the total dry weight of the body 200—including all values and sub-ranges there-between.

Non-limiting examples of filler may include powders of calcium carbonate, including limestone, titanium dioxide, sand, barium sulfate, clay, mica, dolomite, silica, talc, perlite, polymers, gypsum, wollastonite, expanded-perlite, calcite, aluminum trihydrate, pigments, zinc oxide, or zinc sulfate. The filler may be present in an amount ranging from about 25 wt. % to about 99 wt. % based on the total dry weight of the body 120—including all values and sub-ranges there-between.

Non-limiting examples of additive include defoamers, wetting agents, biocides, dispersing agents, flame retardants, and the like. The additive may be present in an amount ranging from about 0.01 wt. % to about 30 wt. % based on the total dry weight of the body 120—including all values and sub-ranges there-between.

The fibers 230 may be organic fibers, inorganic fibers, or a blend thereof. Non-limiting examples of inorganic fibers mineral wool (also referred to as slag wool), rock wool, stone wool, and glass fibers. Non-limiting examples of organic fiber include fiberglass, cellulosic fibers (e.g. paper fiber—such as newspaper, hemp fiber, jute fiber, flax fiber, wood fiber, or other natural fibers), polymer fibers (including polyester, polyethylene, aramid—i.e., aromatic polyamide, and/or polypropylene), protein fibers (e.g., sheep wool), and combinations thereof. Depending on the specific type of material, the fibers 130 may either be hydrophilic (e.g., cellulosic fibers) or hydrophobic (e.g. fiberglass, mineral wool, rock wool, stone wool). The fibers may be present in an amount ranging from about 5 wt. % to about 99 wt. % based on the total dry weight of the body 200—including all values and sub-ranges there-between.

The body 200 in the dry-state may have a density ranging from about 40 kg/m³ to about 250 kg/m³—including all integers and sub-ranges there between. In a preferred embodiment, the body 200 may have a density ranging from about 40 kg/m³ to about 190 kg/m³—including all values and sub-ranges there-between.

The body 200 may have a first volume as measured by the space existing between the upper surface 212, the lower surface 211, and the side surfaces 213. The body 200 may further comprise a core 260 that is encapsulated by the upper surface 212, the lower surface 211, and the side surfaces 213. The core 260 may be formed of the same fibrous material 230 and binder as the rest of the body 200.

The core 260 of the body 200 may occupy a second volume, whereby the second volume may be equal to less than the first volume. In some embodiments the second volume is equal to 10% to about 100% of the first volume—including all percentages and sub-ranges there-between. In a preferred embodiment, the second volume is equal to 90% to about 99.9% of the first volume—including all percentages and sub-ranges there-between.

The second volume of the core 260 may be substantially free of the hydrophobic component. In a preferred embodiment, the second volume of the core 260 is entirely free of the hydrophobic component (i.e., 0 wt. % of the hydrophobic component). When the second volume of the core 260 is equal to the first volume of the body 200, the entire body 200 is substantially free of the hydrophobic component. In a preferred embodiment, when the second volume of the core 260 is equal to the first volume of the body 200, the entire body 200 is entirely free of the hydrophobic component.

In other embodiments, the second volume of the core 260 may be less than the first volume of the body 200. In such embodiments, a portion of the body 200 may comprise the hydrophobic agent as a result of the hydrophobic coating 300 being applied and seeping into the upper and/or lower surface 212, 211 of the body 200. In such embodiments, the amount the hydrophobic coating 300 seeps past the upper and/or lower surface 212, 211 of the body 200 toward the core 260 creates an interface. The interface occupies a third volume in the body 200 that is the difference of the first volume and the second volume. The third volume may be equal to 0% to about 90% of the first volume—including all percentages and sub-ranges there-between. In a preferred embodiment, the third volume may be equal to about 0% to about 10% of the first volume—including all percentages and sub-ranges there-between. In a preferred embodiment, the third volume may be equal to about 0.1% to about 10% of the first volume—including all percentages and sub-ranges there-between.

The hydrophobic coating 300 of the present invention provides at least one major surface 111, 112 of the building panel 100 with a level of hydrophobicity that prevents stain-causing liquid water from being absorbed into the building panel 100 under atmospheric conditions. Specifically, a liquid water leak (e.g., liquid water leaking from mechanical line 9), which is positioned above the building panel 100 in the installed state (as shown in FIG. 7), will not penetrate the building panel 100 and pass from the second major surface 112 to the first major surface 111 of the building panel 100 under atmospheric conditions. Rather, the building panel 100 of the present invention repels the leaking liquid water and forces it to remain on the exterior of the second major surface 112, first major surface 111, and side surface 113 of the building panel 100, thereby preventing adsorption and creation of a stain on the building panel 100. For building panels formed from a body that has not be coated with the hydrophobic coating 300, the liquid water would be absorbed and form a visible stain on at least one of the outer surfaces of the untreated building panel.

The added benefit of liquid water repellency is that the building panel 100 of the present invention may serve as a limited protective barrier to the below active room environment 2. Specifically, by preventing liquid water from passing through the building panel 100, objects positioned directly beneath the building panel 100 will be protected from a vertically offset liquid water leak. For example, the building panel 100 may temporarily protect an object (e.g., a computer), which is located in the active room environment 2 and beneath a leak in the plenary space 3, from water-damage when the building panel 100 is positioned vertically between the leak and the object.

Another benefit of the present invention is that the stain-repellant body 200 is porous (also referred to as “porous body”). While the porous body 200 may successfully repel liquid water from penetrating and passing through the building panel 100, the porous body 200 may still allow for air and water vapor to flow between the first major surface 111 and the second major surface 112 of the building panel 100 such that it allows for enough airflow (under atmospheric conditions) for the building panel 100 to function as an acoustic ceiling panel, which requires properties related to noise reduction and sound attenuation properties—as discussed further herein.

For a porous body, the body 200 of the present invention may have a porosity ranging from about 60% to about 98%—including all values and sub-ranges there between. In a preferred embodiment, the body 120 has a porosity ranging from about 75% to 95%—including all values and sub-ranges there between. According to the present invention, porosity refers to the following:

% Porosity=[V_{Total}−(V_{Binder}+V_{F}+V_{HC}+V_{Filler})]/V_{Total}

Where V_{Total} refers to the total volume of the body 200 defined by the upper surface 212, the lower surface 211, and the body side surfaces 213. V_{Binder} refers to the total volume occupied by the binder in the body 200. V_{F} refers to the total volume occupied by the fibers 230 in the body 200. V_{filler} refers to the total volume occupied by the filler in the body 200. V_{HC} refers to the total volume occupied by the hydrophobic component in the body 200. Thus, the % porosity represents the amount of free volume within the body 200.

The building panel 100 of the present invention comprising the porous body 200 may exhibit sufficient airflow for the building panel 100 to have the ability to reduce the amount of reflected sound in a room. The reduction in amount of reflected sound in a room is expressed by a Noise Reduction Coefficient (NRC) rating as described in American Society for Testing and Materials (ASTM) test method C423. This rating is the average of sound absorption coefficients at four ⅓ octave bands (250, 500, 1000, and 2000 Hz), where, for example, a system having an NRC of 0.90 has about 90% of the absorbing ability of an ideal absorber. A higher NRC value indicates that the material provides better sound absorption and reduced sound reflection.

The building panel 100 of the present invention exhibits an NRC of at least about 0.5. In a preferred embodiment, the building panel 100 of the present invention may have an NRC ranging from about 0.60 to about 0.99—including all value and sub-ranges there-between.

In addition to reducing the amount of reflected sound in a single room environment, the building panel 100 of the present invention should also be able to exhibit superior sound attenuation—which is a measure of the sound reduction between an active room environment 2 and a plenary space 3. The ASTM has developed test method E1414 to standardize the measurement of airborne sound attenuation between room environments 3 sharing a common plenary space 3. The rating derived from this measurement standard is known as the Ceiling Attenuation Class (CAC). Ceiling materials and systems having higher CAC values have a greater ability to reduce sound transmission through the plenary space 3—i.e. sound attenuation function.

The building panels 100 of the present invention may exhibit a CAC value of 30 or greater, preferably 35 or greater.

According to the present invention, the body 200 may be formed according to a standard wet-laid process that uses an aqueous medium (e.g., liquid water) to transport and form the body components into the desired structure. The basic process involves first blending the various body ingredients (e.g., fibers, binder, filler, etc.) into an aqueous slurry—(i.e., the wet-state), transporting the slurry to a head box forming station, and distributing the slurry over a moving, porous wire web into a uniform mat having the desired size and thickness. Water is removed, and the mat is then dried (i.e., the dry-state). The dried mat may be finished into the body by slitting, punching, coating and/or laminating a surface finish to the tile.

The body 200 in the wet-state may be heated at an elevated temperature ranging from about 60° C. to about 300° C.—including all values and sub-ranges there-between—to dry the body 200 from the wet-state to the dry-state. No hydrophobic agent is added to the body 200 during the wet-laid process. The resulting body 200 is substantially free of hydrophobic agent—preferably the body 200 is entirely free of hydrophobic agent.

After manufacturing the body 200, the hydrophobic coating 300 of the present invention the—including the back-coating 350 and/or face-coating 360—may be applied to the body 200. Specifically, the various layers may be applied individually, in a wet-state, by spray coating, roll coating, dip coating, and a combination thereof—followed by drying at a temperature ranging from about 60° C. to about 300° C.—including all values and sub-ranges there-between.

### EXAMPLES

The following experiment tests the water and stain repellency of building panels comprising a body coating with a hydrophobic coating. The hydrophobic agent is a blend of (A) paraffin wax and (B) non-ionic fatty alcohol-polyoxyethylene ether. The body is formed from a blend of mineral fiber, recycled cellulosic fiber, and starch based binder. The body was prepared by mixing together the fibers, binder, and filler with water to form a slurry, which was then agitated for a period of time and then formed into a body by a wet-laid process. The body was then dried at a temperature of about 204° C. The body is free of the hydrophobic agent.

Experiment 1

The building panel of Example 1 was prepared by applying a back coating comprising the hydrophobic agent was applied to the upper surface of the body, whereby the hydrophobic agent was present in an amount of about 2 wt. % based on the total weight of the back coating. A first control building panel (“Control 1”) was prepared where an identical body was prepared and no back-coating is applied.

The building panels were then subjected to a drip test, whereby water is applied by drip at a constant rate to the second major surface (i.e., the back surface of the building panel that faces the plenary space in a ceiling system) for a period of 5 hours. The second major surface of the building panel was then observed for water absorption and staining. The results are provided below in Table 1.

TABLE 1

| | Control | Ex. 1 |
|---|---|---|
| Hydrophobic Front-Coating | No | Yes |
| Hydrophobic Agent | — | Yes |
| Water Absorption | Partial | No |
| Back Surface Stain | Yes | No |
| Edge Surface Stain | Yes | No |

The building panel of Example 1 having the back-coating applied not only exhibited no staining on the second major surface, but also exhibited no water absorption on the second major surface of the panel as well as no staining on the side surface of the building panel.

Experiment 2

The following experiment was prepared using the same type of body as used in Experiment 1. The building panel of Example 2 was prepared by applying a face-coating comprising the hydrophobic agent was applied to the lower surface of the body, whereby the hydrophobic agent was present in an amount of about 10 wt. % based on the total weight of the face-coating. The resulting first major surface of the building panel comprises the hydrophobic coating. A second control building panel (“Control 2”) was prepared where an identical body was prepared and no back-coating is applied. Both the building panels of Example 2 and Control 2 included a decorative coating pre-applied to the lower surface of the body, whereby the decorative coating comprises white pigment.

The building panels were then subjected to a washing test—whereby the first major surface of the building panel was scrubbed using a water-wet material to simulate a cleaning cycle of a panel (e.g., the face of a panel being scrubbed clean after accumulation of dust and dirt over a prolonged period of time). The first major surface of the building panel was then observed for water absorption and staining. The results are provided below in Table 2.

TABLE 2

| | Control 2 | Ex. 2 |
|---|---|---|
| Decorative Face Coating | Yes | Yes |
| Hydrophobic Face-Coating | No | Yes |
| Hydrophobic Agent | — | Yes |
| Water Absorption | Yes | No |
| Front Surface Stain | Yes | No |

The building panel of Example 2 comprising the hydrophobic face-coating withstood staining after scrubbing with a water-wet material.

1. A water repellent building panel having a first major surface opposite a second major surface and side surfaces extending between the first and second major surfaces, the building panel comprising:
a body having an upper surface opposite a lower surface and side surfaces extending between the upper and lower surfaces; and
a coating applied to the upper surface of the body, the coating comprising a hydrophobic agent that is a blend of an olefin and a non-ionic fatty-alcohol;
wherein the body is substantially free of the hydrophobic agent.

2. The building panel according to claim 1, wherein the non-ionic fatty-alcohol is fatty-alcohol polyethoxyethlene ether.

3. The building panel according to claim 1, wherein the olefin is paraffin wax.

4. The building panel according to claim 1, wherein the hydrophobic agent further comprises an emulsifier.

5. The building panel according to claim 1, wherein the hydrophobic agent is present in an amount ranging from about 0.5 wt. % to about 10.0 wt. % based on the total weight of the coating.

6. The building panel according to claim 1, wherein the coating comprises a pigment and the hydrophobic agent is present in an amount ranging from about 5 wt. % to about 10 wt. % based on the total weight of the coating.

7. The building panel according to claim 1, wherein the body comprises a fibrous material.

8. The building panel according to claim 7, wherein the fibrous material is selected from the group consisting of a mineral fiber, cellulosic fiber, polymeric fiber, or a combination thereof.

9. The building panel according to claim 7, wherein the body has an NRC value of at least 0.5 as measured from the upper surface to the lower surface of the body and the building panel is an acoustic ceiling panel.

10. The building panel according to claim 1, wherein the body further comprises a polymeric binder.

11. The building panel according to claim 10, wherein the polymeric binder is selected from starch polymer, latex polymer, and combinations thereof.

12. The building panel according to claim 1, wherein the body is formed from gypsum.

13. (canceled)

14. A water-repellent building panel comprising:
a body having a first volume as defined by plurality of outermost surfaces, the body comprising a core that is encapsulated by the plurality of outermost surfaces; and
a coating applied to at least one of the outermost surfaces of the body, the coating comprising a hydrophobic agent that is a blend of olefin and a non-ionic fatty-alcohol;
wherein the core of the body is substantially free of the hydrophobic agent.

15. The water-repellent building panel according to claim 14, wherein the core has a second volume that is about 10% to about 99% of the first volume.

16. The water-repellent building panel according to claim 14, wherein the non-ionic fatty-alcohol is fatty-alcohol polyethoxyethlene ether.

17. The water-repellent building panel according to claim 14, wherein the olefin is paraffin wax.

18. A method of forming a water-repellent panel comprising:
a) providing a body having a first major surface opposite a second major surface and side surfaces extending between the first and second major surfaces, the body being substantially free of water;
b) applying a coating composition to the first major surface of the body, the coating comprising water and a hydrophobic agent that is a blend of olefin and a non-ionic fatty-alcohol;
wherein the body in step a) is substantially free of the hydrophobic agent.

19. The building panel according to claim 18, wherein the non-ionic fatty-alcohol is fatty-alcohol polyethoxyethlene ether.

20. The building panel according to claim 18, wherein the olefin is paraffin wax.

21. The building panel according to claim 18, wherein the hydrophobic agent further comprises an emulsifier.

22.-25. (canceled)
